(19) United States
(12) Patent Application Publication
(10) Pub. No.: US 2015/0107448 A1
(43) Pub. Date: Apr. 23, 2015

(54) CYLINDER BORE AND METHOD OF FORMING THE SAME

(71) Applicant: FORD GLOBAL TECHNOLOGIES, LLC, Dearborn, MI (US)

(72) Inventors: CHRISTOPHER K. PALAZZOLO, ANN ARBOR, MI (US); CLEMENS MARIA VERPOORT, MONHEIM AM RHEIN (DE)

(21) Appl. No.: 14/518,107

(22) Filed: Oct. 20, 2014

(30) Foreign Application Priority Data
Oct. 22, 2013 (DE) 102013221375.1

(51) Int. Cl. F02F 1/00; B24B 33/02; B23P 13/00

(52) U.S. Cl. CPC F02F 1/004; B23P 13/00; B24B 33/02; B23P 2700/50
USPC 92/169.1; 29/888.061

(57) ABSTRACT

In one or more embodiments, a method of forming a coated cylinder bore includes honing a cylinder bore to produce a honed cylinder bore, masking partially the honed cylinder bore to form a partially masked cylinder bore, and contacting the partially marked cylinder bore with an electrolytic bath to form the coated cylinder bore. The method may further include applying a pulsed direct current at a voltage of 400 to 500 volts to the electrolytic bath. The contacting step may be carried out via one or more of plasma electric oxidation, plasma electrolytic deposition and micro arc oxidation.

### RELATED APPLICATION(S)

This application claims the benefit of Germany Patent Application No.: DE 102013221375.1, filed Oct. 22, 2013, the entire contents thereof being incorporated herein by reference.

### TECHNICAL FIELD

The present invention in one or more embodiments relates to a cylinder bore and a method of forming the same.

### BACKGROUND

It may be desirable for cylinder bores of internal combustion engines to have a nearly uniform and relatively small clearance between the internal circumference thereof and the pistons and/or piston rings moving in reciprocal motion therein, so that tribological conditions may be achieved. The cylinder bore may be deformed in operating mode, i.e. has deviations from an ideal cylindrical shape, so that the actual cylindrically produced cylinder bore has a non-cylindrical shape. Such deviations may arise due to mechanical load if, for example, the cylinder head is screwed on. Such deviations may also occur by thermal and/or by dynamic influences. A surface of the cylinder bore which deviates from the cylindrical shape in operating mode may have a negative influence on the tribological system.

EP 1 321 229 B1, for instance, proposes that in the unloaded state the cylinder bore has an initial shape which deviates from the reference shape, i.e. from the cylindrical shape. EP 1 321 229 B1 proposes to produce an initial shape of a cylinder bore which is non-circular and which, due to the aforementioned influences in operating mode, is deformed to a shape which is as round as possible, i.e. as cylindrical as possible.

In DE 10 2007 024 569 A1, DE 10 2007 063 567 A1 and DE 10 2009 007 023 A1 it is also proposed firstly to produce an initial shape of the cylinder bore which in the unloaded state deviates from the cylindrical shape, wherein in operating mode the cylinder bore is deformed to the substantially round shape, i.e. as cylindrical as possible.

Also DE 10 2007 023 297 A1 discloses that (non-circular) machining of the bore adapted to the operating loads and deviating from the cylindrical symmetry would have the advantage that, as a result, the cylinder deformation may be markedly reduced under operating conditions which might be of greater importance for reducing the oil consumption and improving the piston ring adjustment. DE 10 2007 023 297 A1 further discloses that a two-step method is to be provided, wherein precision machining is intended to follow pre-machining. Before the second step is initiated for producing the non-circular initial shape, i.e. before the precision machining is started, DE 10 2007 023 297 A1 provides to apply a sliding layer onto the pre-machined initial shape. According to DE 10 2007 023 297 A1 this is only able to take place by a thermal spraying process, wherein electric arc wire spraying, atmospheric plasma spraying or high-speed flame spraying are conceivable. Also plasma powder spraying may be a suitable spraying method. In this case, DE 10 2007 023 297 A1, in particular, indicates that the layer thickness of the applied layer is not intended to be less than at least 50 microns (μm). Additionally, before the coating, the surface is disclosed to be pre-treated by thermal, mechanical, chemical or water jet-assisted methods.

In the thermal coating methods, molten coating particles at a high temperature and occasionally at very high speed come into contact with the surface to be coated in order to produce the thermally sprayed layer. Here the obvious drawback is that the basic material to be coated is at least partially subjected to thermal treatment so that the material properties thereof may be altered. Additionally, the cylinder block in which the cylinder bore to be coated is heated to a very high temperature, so that the further processing of the cylinder block is delayed for the duration of the required cooling phase.

### SUMMARY

In one or more embodiments, a method of forming a coated cylinder bore includes honing a cylinder bore to form a honed cylinder bore, masking partially the honed cylinder bore to form a partially masked cylinder bore, and contacting the partially marked cylinder bore with a liquid electrolyte of an electrolytic bath to form the coated cylinder bore. The method may further include applying a pulsed direct current at a voltage of 400 to 500 volts to the electrolytic bath. The contacting step may be carried out via one or more of plasma electric oxidation, plasma electrolytic deposition and micro arc oxidation. The cylinder bore may be honed by a shape-generating honing operation. The shape-generating honing operation may include the use of at least one of diamond strips and ceramic strips. Subsequent to the coating step, the method may further include removing undulations on the coated surface via honing.

In another of more embodiments, a coated cylinder bore may be provided to include an inner surface with a coating positioned thereupon, the coating including at least one of an aluminum oxide and a titanium oxide. The coating may have a thickness of 11 to 12 microns.

One or more advantageous features as described herein will be readily apparent from the following detailed description of one or more embodiments when taken in connection with the accompanying drawings.

### BRIEF DESCRIPTION OF THE DRAWINGS

For a more complete understanding of one or more embodiments of the present invention, reference is now made to the one or more embodiments illustrated in greater detail in the accompanying drawings and described below wherein:

FIG. 1 illustratively depicts an individual cylinder bore 1 being visible in an initial shape 2, which has deviations 3 from the circular shape;

FIG. 2 illustratively depicts a cylindrical shape shown with line 5 in dashed lines;

FIG. 3 illustratively depicts undulations on the coating surface; and

FIG. 4 and FIG. 5 illustratively depict views in which the thrust direction and counter-thrust direction are indicated in each case by line 12.

### DETAILED DESCRIPTION OF ONE OR MORE EMBODIMENTS

As referenced in the FIG.s, the same reference numerals are used to refer to the same components. In the following description, various operating parameters and components are described for different constructed embodiments. These specific parameters and components are included as examples and are not meant to be limiting.

A cylinder block may be formed from an aluminum and/or an aluminum alloy and has initially a roughly produced cylinder surface. In a first step a non-cylindrical surface of the cylinder bore is produced in which deviations from the cylindrical shape are specifically incorporated. The cylinder surface may be produced at the same time as the production of the cylinder block, i.e. cast, introduced as a bore or even inserted as a bushing in the block. By means of this roughly produced cylinder bore, i.e. the virtually untreated aluminum, the first step is initiated by a negative shape being present with the desired deviations.

The creation of deviations may take place by honing, in particular a shape-generating honing operation, wherein honing strips, particularly diamond strips or spring-mounted ceramic strips, may be used so that a surface subjected to a shape-generating honing operation is produced.

In the first step of the machining of the previously virtually untreated basic material (aluminum and/or aluminum alloy), particularly of the shape-generating honing operation, approximately the final dimension is achieved, in particular almost the final extent of the deviations from the reference shape. This is advantageous since only a very thin layer is able to be applied by the subsequent coating via electrolysis, wherein the thickness of the layer to be applied (and an optional post-treatment by means of honing) is naturally taken into account during the pre-machining.

Because the applied layer is very thin so that almost the final dimension should already have been achieved with the previous pre-machining.

Due to the shape-generating honing operation a small degree of roughness may be present, wherein the roughness naturally has an influence on the coating. It is advantageous if the pre-machined surface has a roughness ranging from 1 to 4 μm.

Before the coating is applied, the surface is cleaned, in particular degreased.

The coating is applied by electrolysis. In certain embodiments, the coating takes place in an electrolytic bath. To this end, masks may be advantageously provided so that regions which are not intended to be coated are accordingly covered. For masking, a cover may be provided which seals the cylinder bore by suitable methods such as O-ring seals. Due to the masking, therefore, only the surface to be coated is in contact with the electrolyte.

Because the coating applied by electrolysis can be so thin that the previous creation of the initial shape by a shape-generating honing operation is maintained even after the coating. In electrolysis, an electrode is introduced into the cylinder bore. Between the outer circumference of the electrode and the surface of the cylinder bore, an annular gap is formed through which the electrolyte fluid flows. The electrode in this case forms the cathode, wherein the cylinder block forms the anode. A pulsed direct current with a voltage of 400 to 500 volts may be applied, wherein the electrolysis naturally also may take place using unpulsed direct current or with alternating current. Current strengths of 10 to 30 A/dm² may have particular benefits. The coating time may be selected in a range of 2 to 10 minutes, wherein all cylinder bores may be coated at the same time. Naturally, therefore, one respective electrode may also be provided for each cylinder bore.

As a non-limiting example of the coating, a wear-resistant layer may be applied. Input of heat and thus an alteration associated therewith to the properties of the basic material as may be observed in the thermal spraying method, may thus be avoided. Also thermally-induced warpage is avoided. The initial shape remains as it is in the first step of the pre-machining, i.e. the shape-generating honing operation, in particular even with the desired deviations.

By the choice of process parameters, for example, the porosity of the coating may be specifically set so that the oil retention capacity is improved. Thus a reduced sliding friction wear is also improved by the porosity, wherein the hydrodynamic lubrication is improved. Also the coating may have a high degree of hardness, so that the sliding friction in the mixed friction range at low engine speeds is reduced. Thus the life of the engine may be increased.

It is advantageous if an electrolytical coating method is performed for producing, for example, an oxide-ceramic coating. The coating may be carried out using one or a combination of the following methods: Plasma Electric Oxidation (PEO), Plasma Electrolytic Deposition (PED) and Micro Arc Oxidation (MAO). In this case, the formed layers consist of one or more oxides of the basic material, i.e. for example aluminum oxide or titanium oxide. In a combined use of the method, the coating takes place in different successive coating steps, in which the respective coating method is used.

In particular, Plasma Electrolytic Deposition (PED) is carried out, which is produced in a liquid electrolyte. In this case a layer is produced which both grows from the surface into the basic material (aluminum, aluminum alloy) and is created in the direction of the electrode, i.e. virtually into the annular gap. In PED, however, not only layers of aluminum oxide but also layers of other metal oxides, such as for example titanium oxide may be produced.

It is advantageous that when coating is carried out by electrolysis and the PED method in particular a particularly uniform layer thickness may be achieved, viewed in the radial direction, on each internal circumferential region, even in the region of the specifically produced deviations. In this respect, post-machining for removing excess applications of material may be virtually dispensed with, which naturally does not affect optional post-machining for polishing.

The layers thus produced may grow up to a specific depth into the basic material, wherein outwardly the layer has a greater layer thickness deviating therefrom. In this respect, the layer with an overall thickness of 11 to 20 μm may be produced to be very thin. In this respect, the layer thickness growing into the basic material may be approximately 33% (i.e. approximately ⅓) of the layer thickness growing outwardly. If the layer thickness, for example, is 11 to 12 μm, the layer growing into the basic material has a value of approximately 3 μm, wherein the outwardly growing layer has a value of approximately 8 to 9 μm. Even if the layer has a thickness of 20 μm, this is still considered relatively very thin. In this case, approximately 5 μm would grow into the basic material, wherein a layer with a thickness of 15 μm would be created by growing outwardly. By growing into the basic material, the layer is additionally virtually cross-linked with the basic material, which results in a particularly good connection, i.e. a solid connection, i.e. adhesion of the layer to the basic material. Even the removal of heat via the layer is particularly effective in the operation of the internal combustion engine, as the layer is applied by galvanization which, as already mentioned above, leads to a particularly solid binding with the basic material. This layer which is so thin may follow the surface subjected to a shape-generating honing operation particularly well which means that without having to alter the surface subjected to a shape-generating honing operation in its desired design, the layer bears there against.

In comparison therewith, layers which are applied thermally have layer thicknesses of at least 50 to 250 μm.

The layers applied by means of electrolysis are thus considerably thinner than 50 μm and have a hardness of, for example, 1500 HV. Naturally, the properties of the layer, also the layer thickness, the pore size and the roughness of the layer may be adjusted via the process parameters relative to the electrolysis (choice of electrolyte, its concentration and temperature, type of current, density of current, voltage and duration of treatment), as already mentioned. The coating may have a roughness of 2 to 4 μm Rz and peak values of, for example, 0.26 μm Rpk. Pores may have a value of 2 to 3 μm. It is thus advantageous that the initial shape with its deviations from the cylindrical reference shape may be already formed before the coating, wherein the material application during the coating and the low removal of material with optional polishing (further details provided below) are considered. With the deviations, which are substantially compensated in the operating mode, so that in the operating mode a substantially cylindrical bore is formed, the piston rings during operation may ideally bear against the cylinder surface produced.

The layer applied by electrolysis has, on its surface facing into the annular gap, an undulating design which is due to the pores and the layer structure. This surface does not necessarily have to be post-machined if the undulations are small, which is to be expected due to the small degree of roughness of the layer. Optionally, however, in any case post-machining may take place in a further step, wherein the surface may be polished. The post-machining may take place by honing or other known post-machining methods, even roughing or brushing. In certain embodiments, the surface may be post-machined by the shape-generating honing operation with diamond strips or spring-mounted ceramic strips. Thus if honing tools are used for polishing, the honing strip segments thereof are suspended in an oscillating manner, wherein the honing strip segments are relatively short relative to the axial extent of the cylinder bore, wherein the honing strip segments are additionally longer than the short-wave components of the coating profile, so that the desired polishing is able to be achieved. In this case, the material which has been applied is removed to a minimum extent, wherein the geometry of the cylinder bore, i.e. the geometry of the coated cylinder bore, remains virtually unaltered. As mentioned above, for post-machining brushing may also be carried out, wherein honing brushes are used. Optionally, flexible honing brushes may also be used.

During the post-machining for polishing, however, the amount of material removed is kept particularly small, wherein the surface undulations are reduced or entirely polished out. In this respect, the optionally finished-honed, polished layer has pores typical of the layer. By the deviations which are substantially compensated in the operating state, so that in the operating state a substantially cylindrical bore is formed, the piston rings in operation may ideally bear against the cylinder surface produced according to the invention.

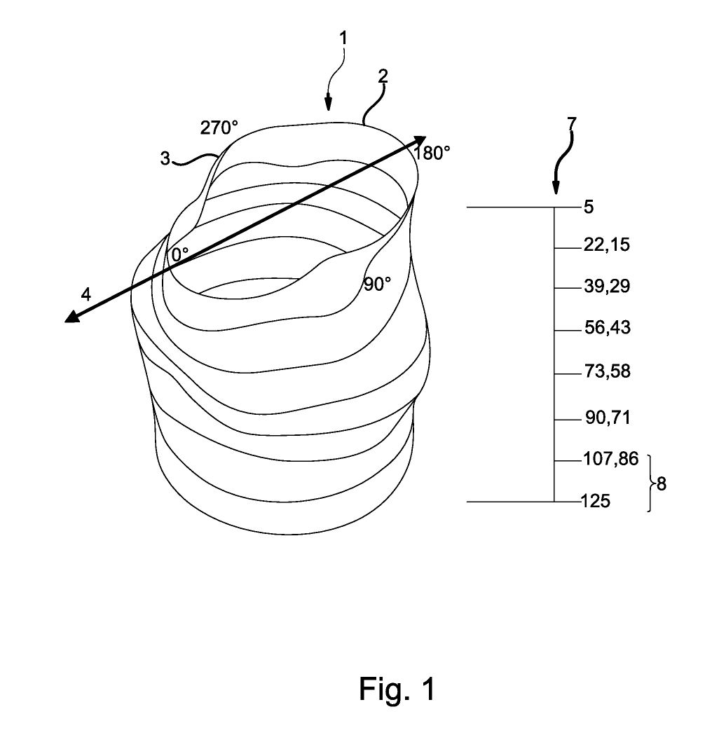

In FIG. 1 an individual cylinder bore 1 is visible in an initial shape 2 to be produced in the model, which has deviations 3 from the circular shape. The initial shape 2 is shown here in an unloaded state. The cylinder bore 1 is a component of an internal combustion engine, not shown, which may also have more than one cylinder bore. The cylinder bore 1 is arranged in a cylinder block, not shown, which by way of example consists of an aluminum or aluminum alloy. The illustrated arrow 4 represents the crankshaft alignment. The basic material (aluminum, aluminum alloy) of the cylinder block, i.e. the cylinder bore, is in the un-machined form, i.e. as a blank of cylindrical shape, wherein the initial shape 2 visible in FIG. 1 may be produced.

The initial shape 2 is intended to be produced so as to be non-circular in the unloaded state, as the cylinder bore is deformed in the operating state, i.e. in the loaded state. The deviations are calculated, i.e. modeled, such that the deformation of the cylinder bore in the operating state, i.e. in the loaded state, is no longer present, so that in the operating state a substantially cylindrical cylinder bore 1 is achieved.

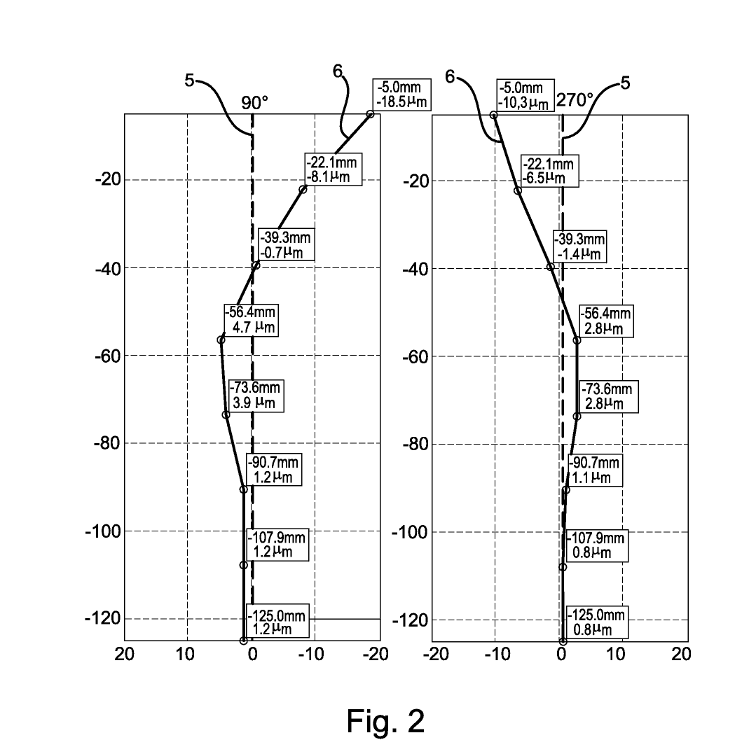

In FIG. 2 a cylindrical shape using the line 5 shown by dashed lines is visible by way of example for a bore with a diameter of 92.2 mm. The deviations from the non-circularity are visible in FIG. 2 via the continuous line 6.

In FIG. 1 additionally a measurement scale 7 is illustrated. The measurement scale being intended to reveal the spacing from the cylinder block deck in the direction of the crankshaft chamber. In a lower region 8, i.e. in the region of the crankshaft chamber, the initial shape 2 to be produced is intended to have a cylindrical region. This is because even in the operating mode a deformation from the cylindrical non-circularity is not likely to be expected here.

In the direction of the cylinder block deck, in the loaded state deformations have to be taken into account, so that the deformations may accordingly be introduced into the initial shape 2 such that the deformations in the loaded state are ideally completely compensated.

To this end, the initially untreated blank of the cylinder block in which the cylinder bore is incorporated (see FIG. 2, line 5) is machined by a shape-generating honing operation. Naturally, the line 5 does not represent the inner wall of the blank to be machined. The line 5 is intended to represent the ideal cylindrical shape under load.

During the shape-generating honing operation, the structures visible in the model of the initial shape 2 shown in FIG. 1 are incorporated into the cylinder block, i.e. in the blank of the cylinder bore 1. The spacing from the cylinder block deck is to be determined in each case by way of example at successive exemplary points in the vertical direction. Deviations from the non-circularity are assigned to these exemplary points, so that using the line 6 the surface to be subjected to a shape-generating honing operation is visible.

If the surface according to the model shown in FIG. 1 is subjected to a shape-generating honing operation, the surface subjected to a shape-generating honing operation is coated, and in particular coated with a wear-resistant and hard layer. Non-limiting examples of method for applying the layer include an electrolytical method, and particularly Plasma Electrolytic Deposition (PED).

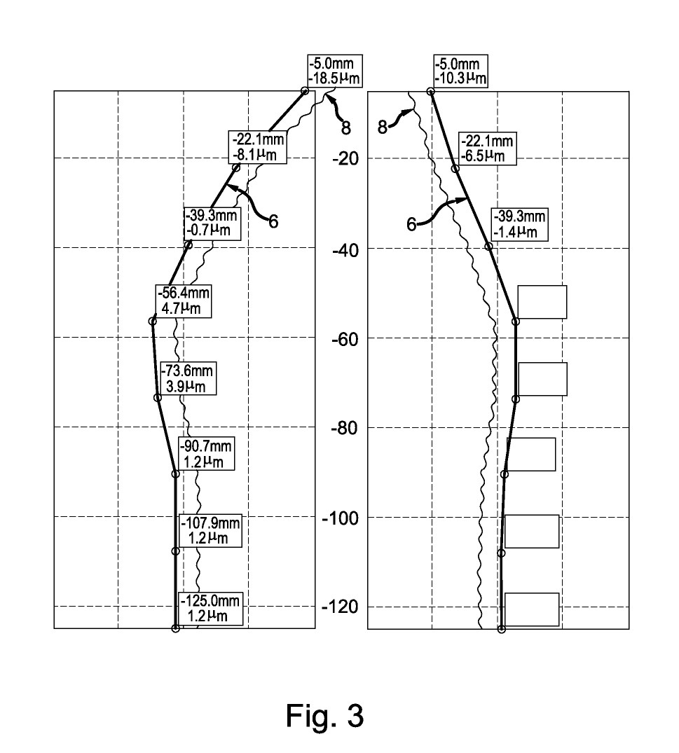

Thus the coating is applied by galvanization, wherein one portion of the coating grows into the basic material and a further portion is created in the direction of the central vertical axis of the cylinder bore. By way of example, the coating has an overall layer thickness of about 11 microns (μm), of which approximately 3 μm grows into the basic material and approximately 8 μm is created in the direction of the central vertical axis, i.e. relative to the surface originally subjected to a shape-generating honing operation (line 6). Such a layer 8 is visible in FIG. 3, wherein the layer component growing into the basic material is not shown.

The coating is thus very thin and follows the surface subjected to a shape-generating honing operation without having to alter the design according to the predetermined initial shape 2. This is the particular advantage of the electrolytical coating since it does not necessarily have to be post-machined. The selected view of the undulations of the coating surface in FIG. 3 is naturally exaggerated. Similarly, the surface of the coating 8 may be optionally polished, for which honing methods, preferably a shape-generating honing operation, may be carried out.

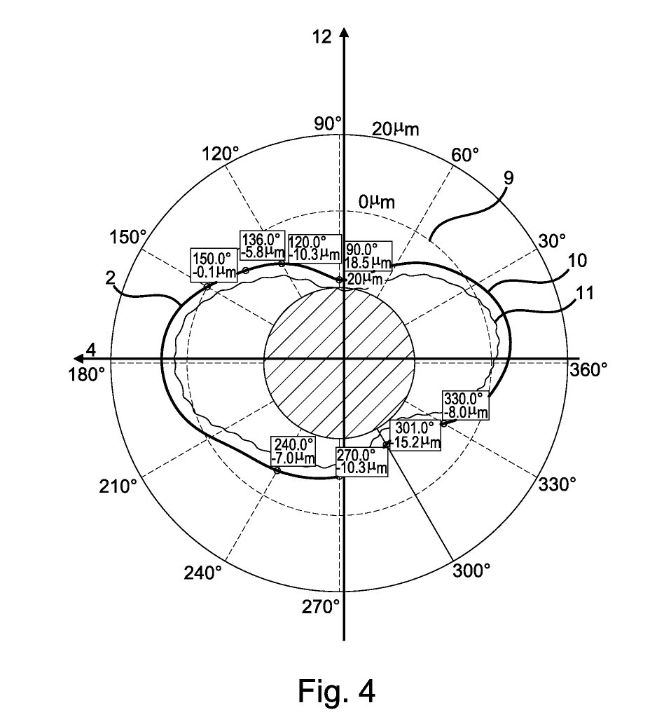

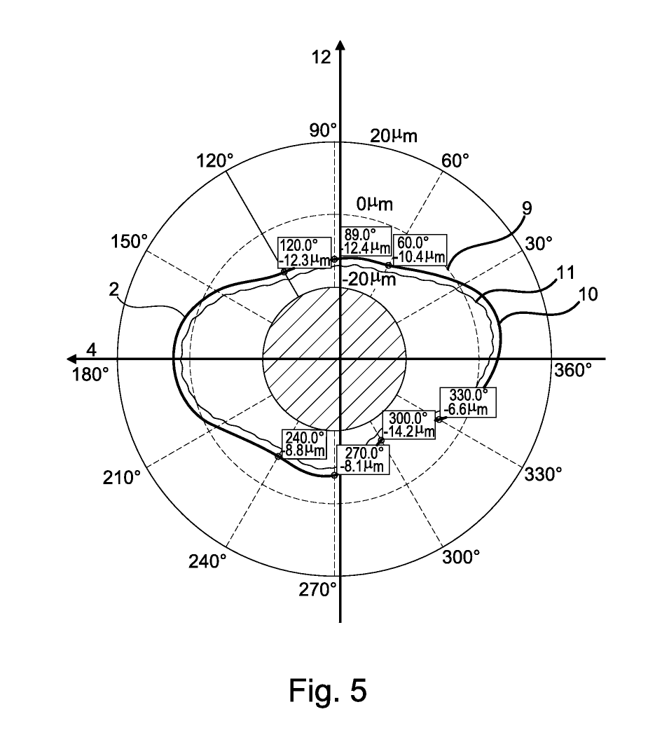

In FIG. 4 and FIG. 5, a cross section is shown at a distance of 5 millimeters (mm) (FIG. 4) and 15 mm (FIG. 5) from the cylinder block deck. The dotted line 9 is intended to represent the ideal cylindrical reference shape under load. The line 10 shows the surface subjected to a shape-generating honing operation with the modeled deviations. In this case, viewed in the circumferential direction, by way of example, the even numbers are the deviation values assigned to the initial shape 2 in the model. The line 11 which in turn shows, as in FIG. 3, the layer 8 with its undulating surface. Naturally the layer construction of the layer 8 should be regarded as uniform and not non-uniform which is merely due to the inaccuracies of the drawing. In FIG. 4 and FIG. 5 the thrust direction and counter-thrust direction are indicated in each case via the line 12.

In one or more embodiments, the present invention as set forth herein is believed to have overcome certain challenges faced by known production of cylinder bore and in particular cylinder bore for an internal combustion engine. However, one skilled in the art will readily recognize from such discussion, and from the accompanying drawings and claims that various changes, modifications and variations can be made therein without departing from the true spirit and fair scope of the invention as defined by the following claims.

1. A method of forming a coated cylinder bore, comprising:
honing a cylinder bore to form a honed cylinder bore;
masking partially the honed cylinder bore to form a partially masked cylinder bore; and
contacting the partially marked cylinder bore with a liquid electrolyte of an electrolytic bath to form the coated cylinder bore.

2. The method of claim 1, further comprising applying a pulsed direct current at a voltage of 400 to 500 volts to the electrolytic bath.

3. The method of claim 1, wherein the contacting step is carried out via one or more of plasma electric oxidation, plasma electrolytic deposition and micro arc oxidation.

4. The method of claim 1, wherein the cylinder bore is honed by a shape-generating honing operation.

5. The method of claim 4, wherein the shape-generating honing operation includes the use of at least one of diamond strips and ceramic strips.

6. The method of claim 1, wherein the coating is formed to have a thickness of 11 to 12 microns.

7. The method of claim 1, further comprising degreasing the honed cylinder bore prior to applying the coating.

8. The method of claim 1, further comprising, subsequent to the coating step, subjecting the coated cylinder bore to a second honing.

9. A method of forming a coated cylinder bore, comprising:
honing a cylinder bore to form a honed cylinder bore with an initial shape, the initial shape in an unloaded state including deviations from a reference shape; and
applying a coating to the honed cylinder bore by electrolysis to form the coated cylinder bore.

10. The method of claim 9, wherein the electrolysis is carried out by contacting the honed cylinder bore with a liquid electrolyte in an electrolytic bath.

11. The method of claim 10, further comprising, prior to the electrolysis, the honed cylinder bore is partially masked such that certain portions of the honed cylinder bore are not in contact with the liquid electrolyte.

12. The method of claim 9, wherein the electrolysis is carried out via a pulsed direct current at a voltage of 400 to 500 voltz.

13. The method of claim 9, wherein the electrolysis is carried out via one or more of plasma electric oxidation, plasma electrolytic deposition and micro arc oxidation.

13. (canceled)

14. The method of claim 9, wherein the cylinder bore is honed by a shape-generating honing operation including the use of at least one of diamond strips and ceramic strips.

15. The method of claim 9, further comprising degreasing the honed cylinder bore prior to applying the coating.

16. The method of claim 9, further comprising, subsequent to the coating step, subjecting the coated cylinder bore to a second step of honing.

17. A coated cylinder bore comprising:
an inner surface with a coating positioned thereupon, the coating including at least one of an aluminum oxide and a titanium oxide.

18. The coated cylinder bore of claim 17, wherein the coating has a thickness of 11 to 12 microns.

19. The coated cylinder bore of claim 17, wherein the coating has a roughness of 2 to 4 μm Rz.

20. The coated cylinder bore of claim 17, wherein the coating has pores with a size value of 2 to 3 μm.
